(19) United States
(12) Patent Application Publication
(10) Pub. No.: US 2002/0131671 A1
(43) Pub. Date: Sep. 19, 2002

(54) Fibre optic switching device

(76) Inventor: Raja Singh Tuli, Montreal (CA)

Correspondence Address: RAJA SINGH TULI, 555 RENE LEVESQUE WEST, Suite 1130, Montreal, QC, H3B3T6, CA

(21) Appl. No.: 09/803,891

(22) Filed: Mar. 13, 2001

(51) Int. Cl. G02B 6/35

(52) U.S. Cl. 385/16; 385/17

(57) ABSTRACT

The invention relates to a high speed fiber optic packet switching device. A data stream is divided into standardized packets sent through the fiber optic network, where specific packet switches or routers sort and direct each single packet to its destination. Packets are generated in groups of slightly different phases and are sent to the switching device, whereby each packet in a group enters the input of the switch at the same time, and are made to constructively interfere with each other in the area of the output fiber through which the packet is intended to be routed. This allows the packet to instantly enter and travel along the new output fiber path towards its destination. In all other areas on the output side of the optical switch, packets destructively interfere with each other so that no packet enters any other output.

### BACKGROUND OF THE INVENTION

1. Field of the Invention

The invention relates to a fiber optic packet switching device that utilizes the theory of constructive and destructive interference of light waves within the switching device, to route standardized packets of information along a network to their destination.

2. Prior Art

In principle, two basic technologies are used to build high capacity networks: circuit switching and packet switching. In circuit switched networks, network resources are reserved all the way from sender to receiver before the start of the transfer, thereby creating a circuit. The resources are dedicated to the circuit during the entire transfer. An advantage of circuit-switched networks is that they allow for large amounts of data to be transferred with guaranteed transmission capacity. A disadvantage of circuit switching is that if connections are short lived when transferring short messages, the setup delay may represent a large portion of the total connection time, thus reducing the network's capacity. Furthermore, reserved resources cannot be used by any other users even if a circuit is inactive, further reducing link utilization.

Packet switching was developed to more effectively cope with the data transmission limits of the circuit-switched networks during bursts of random traffic. In many aspects, a packet-switched network is a network of queues. Each network node contains queues where incoming packets are queued before they are sent out on an outgoing link. If the rate at which packets arrive at a switch point exceeds the rate at which packets can be transmitted, the queues grow. This happens, for example, if the packets from several incoming links have the same destination link. The queuing causes delay, and if the queues overflow, packets are lost, which is commonly referred to as congestion. Loss of data generally results in retransmissions further congesting the network. The ability to support real time traffic in packet switched networks thus calls for advanced control mechanisms, hence the need for a faster switching solution to relieve network congestion as the present invention provides.

### SUMMARY OF THE INVENTION

The present invention relates to a high-speed fiber optic packet switching device. In packet switching, a data stream is divided into standardized packets. Each packet contains an address, size, sequence, and error checking information, in addition to the payload data. The packets are then sent through the fiber optic network where specific packet switches or routers sort and direct each single packet to its destination. Packets are treated independently of each other inside the network because complete information concerning the packet destination is contained in each packet. Each packet contains a channel identifier that is used at the switches to guide each packet to the correct destination.

A principal embodiment has the same packet of data reproduced many times, each time of a slightly different phase, and sent consecutively as a group to the input of the optical switch of the invention. Prior to reaching the switch, the input is spliced with multiple sub inputs of various lengths from the splice location to the switch. Hence, by delaying packets and sending them along routes of different lengths, it is possible to have all packets in a group appear at all sub-inputs at the switch simultaneously. An array of outputs are strategically located opposite the input array such that packets of data comprising light pulses constructively interfere with each other in the vicinity of the output of the switch, where the packet is intended to be routed. In locations of constructive interference, packets instantaneously enter the output of the switch at that location. In all other areas destructive interference occurs and no other packet enters any other output.

Other embodiments involve alternate means to reproduce packets of data and direct them to the array of inputs on the optical switch, to subject these packets to constructive interference as the principle means of routing packets to the destination path or fiber on the output array. Packets may also travel in groups on top each other of different wavelengths, and prior to reaching the switch, they are all converted to the same wavelength and enter the sub-inputs of the switch simultaneously, where again constructive interference is the principle means of routing packets to the destination path or fiber on the output array.

### BRIEF DESCRIPTION OF THE DRAWINGS

The invention is described in more detail below with respect to an illustrative embodiment shown in the accompanying drawings in which:

FIG. 1 illustrates a typical fiber optic switch in accordance with Prior Art.

FIG. 2 illustrates a typical packet of data in accordance with Prior Art.

FIG. 3 illustrates a group of packets in accordance with the present invention.

FIG. 4 illustrates a packet switch in accordance with the present invention.

FIG. 5 illustrates a packet switch in accordance with another embodiment the present invention.

FIG. 6 illustrates a packet switch in accordance with a further embodiment the present invention.

FIG. 7 illustrates the delay of packets along input fibers in accordance with the present invention.

### DETAILED DESCRIPTION OF THE PREFERRED EMBODIMENTS

To facilitate description, any numeral identifying an element in one figure will represent the same element in any other figure.

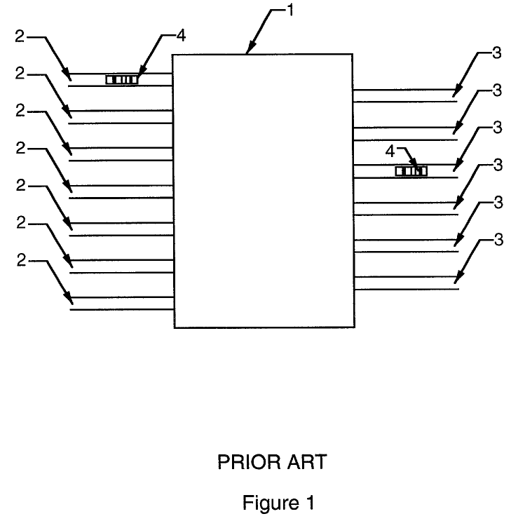

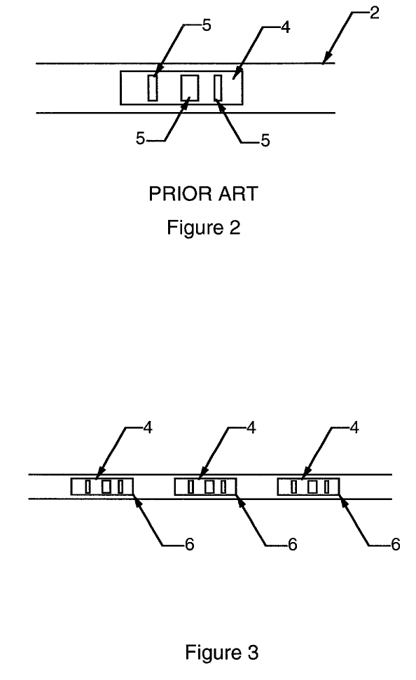

The present invention relates to a fiber optic packet switching device as illustrated in a typical switch of Prior Art in FIG. 1. Fiber optic switches 1 comprise an array of input fibers 2 and an array of output fibers 3. A packet of data 4 travelling along a fiber, enters the switch 1 through one of the inputs fibers 2 and gets routed to a specific output fiber 3 based on address information contained in the header of the packet. The routing methods of prior art usually involve a system of micro mirrors, or other electronic switching techniques. In optical switching or packet switching, a data stream is divided into standardized packets 4 as further illustrated in FIG. 2. Each packet 4, which is carried in an optical fiber 2, consists of pulses of light energy 5 following each other rapidly. Packets may be typically 100 bytes in size each containing information on its address, size, sequence, and error checking information, in addition to the payload data.

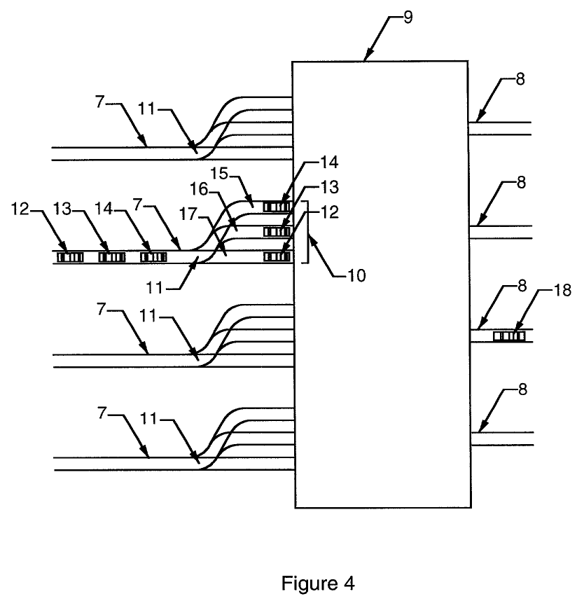

In accordance with the present invention, each packet of information to be sent to a specific destination is generated in groups, as illustrated in FIG. 3. Packets 4 of the same group are sent in succession along the same fiber such that each packet is identical to others in the group, except that they are slightly off-phase. In particular, multiple packets are generated identically in each group except for a slight phase difference based on a specific starting point 6, which is critical to the invention. Since the only place that knows each packet's destination is the point at which they are generated, this is where the phases are set accordingly. With further reference to FIG. 4, the present invention describes a switching device 9 which contains many input fibers 7 and many output fibers 8. The switching device 9 can switch or route packets 4 from any one input 7 to any of the output fibers 8, as determined by the destination address contained in the header of each packet. Prior to reaching the switching device 9 each input fiber is spliced at a specific location 11 with other fibers of different lengths leading to the same input location of the switching device. Hence, each input fiber 7 is spliced to contain multiple sub-inputs 10 which enter the switching device 9. Hence, when a group of packets 4 are travelling along a fiber path from the originating point to the switch 9, by sending the first packet along the longest route at the spliced location 11, and the next packet sent along the next longest route at the splice and so on, all the packets in the group can appear simultaneously at the sub-inputs 10 to enter the switching device 9 at the exact time. This is achieved by providing detailed information to the source that generates these packets, on the distance each packet has to travel from the spliced location 11 to respective sub-inputs 10, to enable each packet in a group to be sent at the proper time, maintaining precise intervals between packets, such that all packets arrive at the exact instant at each sub-input. Thus, packet 14 which is first in its group, takes path 15 which is the longest path after the spliced location 11, and arrives at the same instant at sub-input 10 as packet 13 which is further behind in the same fiber of the same group but travels less distance after the spliced location 11 along path 16. Similarly, packet 12 which is furthest behind in the same fiber of the same group, but travels the least distance after the spliced location 11 along path 17, also arrives at the same instant at sub-input 10 as packets 13 and 14. Therefore, all packets in a particular group sent one after the other along the same fiber arrive at all sub-inputs 10 of the respective input fiber 7 at the same instant, and since the phases of each packet in a group are different, upon entering the switching device 9, they are made to interfere with each other so that constructive interference occurs at one of the output fibers 8 where the packet was intended to be routed, thus allowing the packet 18 to enter the output fiber and travel to its destination. In all areas of other output fibers destructive interference occurs, thus no packet is allowed to enter any output fiber of the switch device 9.

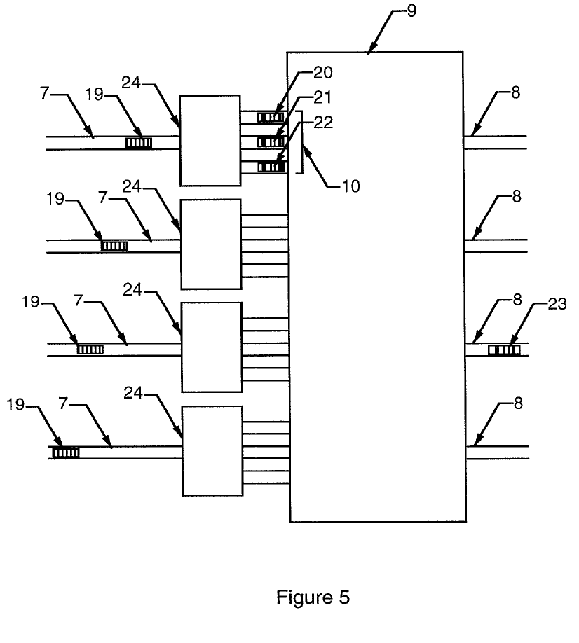

In an another embodiment of the present invention, with reference to FIG. 5, each packet of information to be sent to a specific destination is generated in groups whereby these packets are not sent one after the other, but all of them are on top of each other at the same time slot of a different wavelength. Hence, a single packet 19 is sent along an input fiber 7 containing multiple packets generated identically in each group except for a slight phase difference based on a specific starting point 6 (FIG. 3), and a difference in wavelength. Prior to reaching the switching device 9 the packet 19 enters a converter 24 where the wavelengths are converted such that the packets 20, 21 & 22 in that group are separated from each other, whereby the wavelengths of packets 21 & 22 are also converted to the same wavelength as packet 20, with all packets appearing simultaneously at the sub-inputs 10, to enter the switching device 9 at the exact time. Therefore, as all packets in a particular group arrive at all sub-inputs 10 at the same instant, and since their wavelengths are identical but their phases are different, upon entering the switching device 9, they are made to interfere with each other so that constructive interference occurs at one of the output fibers 8 where the packet was intended to be routed, thus allowing the packet 23 to enter the output fiber and travel to its destination. In all areas of other output fibers destructive interference occurs, thus no packet is allowed to enter any output fiber of the switch device 9.

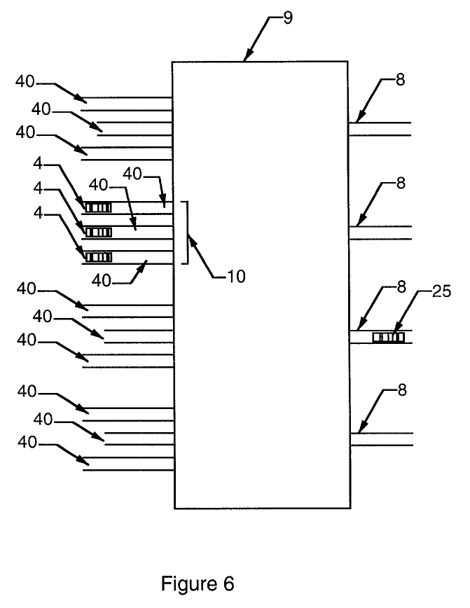

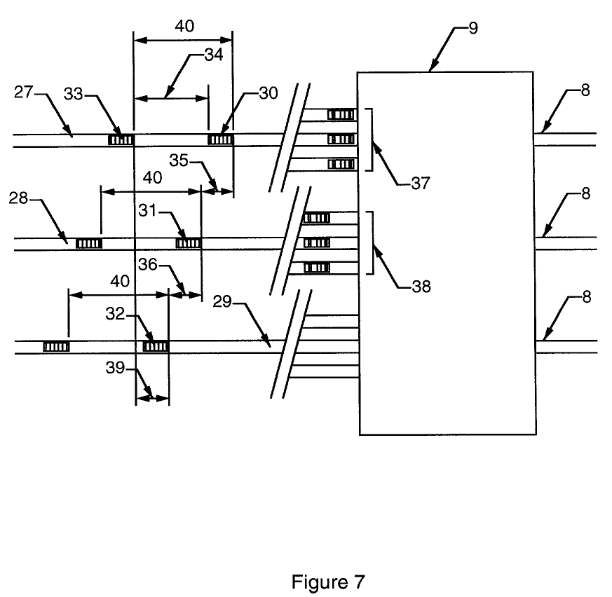

In a further embodiment of the invention, in accordance with FIG. 6, packets 4 generated in a group are sent individually via independent fiber optic lines 40, to arrive simultaneously at all sub-inputs 10 of the optical switch 9. Therefore, as all packets 4 in a particular group arrive at all sub-inputs 10 at the same instant, and since their phases are different, upon entering the switching device 9, they are made to interfere with each other so that constructive interference occurs at one of the output fibers 8 where the packet was intended to be routed, thus allowing the packet 25 to enter the output fiber and travel to its destination. In all areas of other output fibers destructive interference occurs, thus no packet is allowed to enter any output fiber.

In another embodiment of the invention, in accordance with FIG. 7, the switching device 9 contains multiple input fibers 27, 28, 29 with multiple output fibers 8. Packets are generated in groups and travel along individual fibers in time slices. Hence group 30 travelling along fiber 27 is followed by group 33 with a gap of 34 between these groups. During this gap 34 other input fibers may send groups of packets to the switching device 9. Otherwise, when packets from a particular input fiber 27 are separated from their respective group and appear at the sub-input 37 of the switch 9, they may interfere with packets appearing simultaneously at sub-input 38 of another input fiber 28. Therefore, to avoid this, the present invention sends groups of packets in time slices or intervals along each fiber to allow other groups of packets along other fibers to be routed during these intervals. Hence, between successive input fibers 27 & 28 there is a delay 35 between the starting points of packets 30 & 31 which prevents packets in group 31 from entering the switching device 9 when packets from group 30 are entering or inside the switching device. The switching device 9 is designed such that all the time slices along each input fiber match up, to prevent interference between packets of different groups. The sources that generate these packets of different phases in each group, would send each group in time slices along the same fiber such that delays 35, 36 & 39 along successive fibers may be fixed or variable. Hence the distance 40 between the starting points of two groups of packets 30 & 33 travelling one after the other along the same fiber 27 would be the sum of all delays 35, 36 & 39 between all successive fibers leading into the switching device 9. This distance 40 between the starting points of two successive groups in one fiber, would be consistent between any two successive groups in any fiber.

I claim:

1. An optical switching device comprised of an array of inputs and an array of outputs, such that a packet of data comprising light pulses is generated more than once by a source in groups, with each packet in a group differing only in phase from a same reference point, whereby each group is sent to the switching device for packets of data in each group to interfere with each other upon entering an input, thus allowing one packet to enter one output in the area of constructive interference only, to be sent to a destination.

2. An optical switching device as claimed in claim 1 such that packets of data in a group sent at different times within each group by the source, are separated and routed along different paths to arrive at the same input at the same instant.

3. An optical switching device as claimed in claim 1 such that packets of data in a group are converted to different wavelengths, whereby all packets in a group are combined into a single packet which is sent to the switching device, such that each packet in a group is separated and converted back to its original wavelength and sent along different paths to arrive simultaneously at the same input of the switching device.

4. An optical switching device as claimed in claim 1 such that groups of packets sent along an optical fiber are separated by an interval during which, one group of packets travelling along each of all other optical fibers connected to an input, are sent to respective destinations during this interval.

5. An optical switching device as claimed in claim 1 such that in all areas other than the area of constructive interference, destructive interference occurs thus no other packet may enter any other output to be routed to a destination.
